(19) United States
(12) Patent Application Publication
(10) Pub. No.: US 2014/0317709 A1
(43) Pub. Date: Oct. 23, 2014

(54) COMPUTER SERVER AND AUTHENTICATION METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LEI JIANG, Shenzhen (CN); SI-QUAN CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/228,550

(22) Filed: Mar. 28, 2014

(30) Foreign Application Priority Data
Apr. 22, 2013 (CN) 2013101398628

(51) Int. Cl. H04L 29/06

(52) U.S. Cl. CPC H04L 63/083
USPC 726/7

(57) ABSTRACT

A computer server system includes a processor that executes a number of modules. The number of modules includes a receiving module to receive an account name inputted by a user, and a password generating module to generate a unique, unchangeable password corresponding to the account name. The computer server system further includes a storage unit to store the account name and the password.

### BACKGROUND

1. Technical Field

The present disclosure relates to a computer server and an authentication method implemented by the computer server.

2. Description of Related Art

Some internet users use the same username and password when registering on different websites. However, if the username and the password on one of the websites is uncovered, other websites become vulnerable to intruders using the uncovered username and password. Thus, there is a need to provide a computer server and an authentication method to solve the aforementioned problem.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic block diagram of an embodiment of a computer server.

FIG. 2 is a flowchart of an embodiment of an authentication method implemented by the computer server of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.” Embodiments of the present disclosure will be described with reference to the accompanying drawings.

The present disclosure provides a computer server that creates a unique, unchangeable password in response to an inputted account name. When the computer servers are used for different websites, they can randomly create different passwords for a user attempting registering on the different websites using the same account name. As a result, if one of the created passwords is uncovered, the data of the user on other websites are safe.

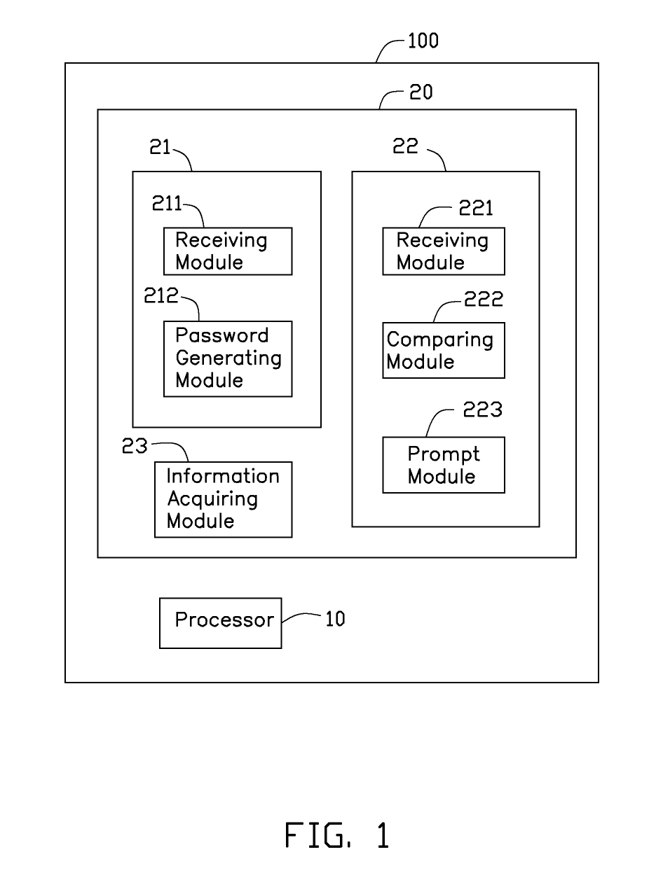

Referring to FIG. 1, a server 100 includes a processor 10 and a storage unit 20 (e.g., a hard disk). The storage unit 20 stores a number of modules that are executable by the processor 10. In one embodiment, the storage unit 20 includes a register module 21, an authentication module 22, and an information acquiring module 23. The register module 21 includes a receiving module 211 and a password generating module 212. The receiving module 211 is used to receive an account name entered by a user. The password generating module 212 is used to randomly generate a unique, unchangeable password corresponding to the account name. In one embodiment, the server 100 does not allow the user to change the generated password. The generated password and the account name are stored in the storage unit 20.

The authentication module 22 includes a receiving module 221, a comparing module 222, and a prompt module 223. The receiving module 221 is used to receive an inputted account name and an inputted password. The comparing module 222 is used to compare only the inputted password with the generated passwords stored in the storage unit 20. If the inputted password matches one of the generated passwords, the information acquiring module 23 acquires information associated with the matching generated password, and presents the information to the user. Otherwise, the prompt module 223 generates a warning message to warn the user that the inputted password is not correct.

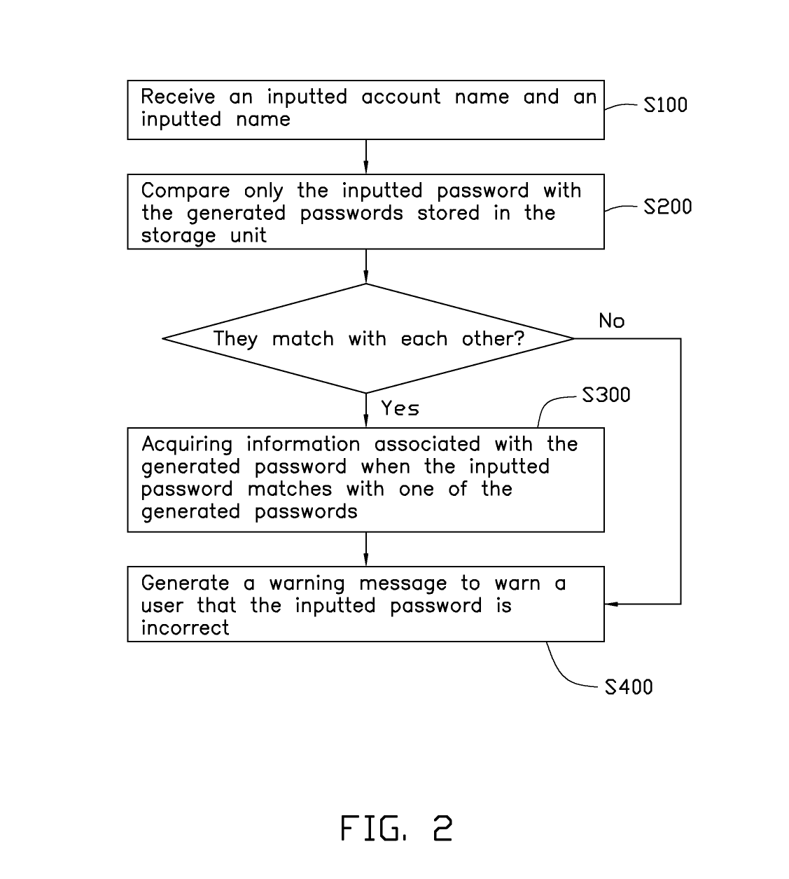

FIG. 2 shows a flowchart of an authentication method implemented by the server 100. In step S100, the receiving module 221 receives an inputted account name and an inputted password. In step S200, the comparing module 222 compares only the inputted password with the generated passwords stored in the storage unit 20. If the inputted password matches one of the generated passwords stored in the storage unit 20, the procedure goes to step S300. Otherwise, the procedure goes to S400. In step S300, the information acquiring module 23 acquires information associated with the matching generated password. In step S400, the prompt module 223 generates a warning message to warn the user that the inputted password is not correct.

Assuming that websites A and B both use servers 100 for providing Internet services, if a user registers the same account name on websites A and B, the servers 100 of websites A and B will randomly generate passwords for the account name. There is low possibility that the generated passwords are the same. Thus, if the generated password for website A is uncovered, user data on website B is safe because the generated passwords for websites A and B are different.

While various embodiments have been described and illustrated, the disclosure is not to be construed as being limited thereto. Various modifications can be made to the embodiments by those skilled in the art without departing from the true spirit and scope of the present disclosure.

What is claimed is:

1. A server system comprising:
a processor configured to execute a plurality of modules, the plurality of modules comprising:
a receiving module configured to receive an account name inputted by a user; and
a password generating module configured to generate a unique, unchangeable password corresponding to the account name;
a storage unit configured to store the account the account name and the password.

2. The server system according to claim 1, wherein the plurality of modules further comprise an authentication module and an information acquiring module, the authenticating module is configured to receive an inputted account name and an inputted password, the authentication module only compares the inputted password with the generated passwords stored in the storage unit, if the inputted password matches with one of the generated passwords, the information acquiring module acquires information associated with the one of the generated passwords.

3. The server system according to claim 2, wherein the plurality of modules further comprise a prompting module, the prompting module is configured to generate a prompt when the inputted password and the generated password do not match.

4. An authentication method implemented by a server system, the server system comprising a processor configured to execute a plurality of modules and a storage unit, the plurality of modules comprising a receiving module configured to receive an account name inputted by a user, and a password generating module configured to generate a unique, unchangeable password corresponding to the account name, the authentication method comprising:
receiving an inputted account name and an inputted name;
comparing only the inputted password with the generated passwords stored in the storage unit;
acquiring information associated with the generated password when the inputted password matches with one of the generated passwords.
